(19) United States
(12) Patent Application Publication
(10) Pub. No.: US 2014/0181726 A1
(43) Pub. Date: Jun. 26, 2014

(54) METHOD AND ELECTRONIC DEVICE FOR PROVIDING QUICK LAUNCH ACCESS AND STORAGE MEDIUM

(71) Applicant: Tencent Technology (Shenzhen) Company Limited, Shenzhen (CN)

(72) Inventors: Baojian WANG, Shenzhen (CN); Liming LlU, Shenzhen (CN); Zhongxing HU, Shenzhen (CN); Xin TUO, Shenzhen (CN); Kang GAO, Shenzhen (CN)

(73) Assignee: Tencent Technology (Shenzhen) Company Limited, Shenzhen (CN)

(21) Appl. No.: 14/195,223

(22) Filed: Mar. 3, 2014

Related U.S. Application Data
(63) Continuation of application No. PCT/CN2013/072298, filed on Mar. 7, 2013.

(30) Foreign Application Priority Data
Apr. 9, 2012 (CN) 201210102052.0

(51) Int. Cl. G06F 3/0484

(52) U.S. Cl. CPC G06F 3/04842
USPC 715/779

(57) ABSTRACT

A method for proving a quick launch access includes: acquiring position information of a Taskbar in an operation interface; creating a self-defined quick launch window, and providing a quick launch access in the self-defined quick launch window; arranging the self-defined quick launch window adjacent to a Start menu bar in the operation interface according to the position information of the Taskbar; and detecting a change of the Taskbar periodically, and adjusting a position of the self-defined quick launch window according to the change of the Taskbar. Further, a device for providing a quick launch access and a storage medium are provided. With the technical solution stated above, the user operation can be improved efficiency.

### CROSS-REFERENCES TO RELATED APPLICATIONS

This application claims priority to and is a continuation of PCT/CN2013/072298, filed on Mar. 7, 2013 and entitled “SHORTCUT ACTIVATION ACCESS PROVIDING METHOD, ELECTRONIC APPARATUS AND STORAGE MEDIUM”, which claims the priority to Chinese Patent Application No. 201210102052.0, filed with the Chinese Patent Office on Apr. 9, 2012 and entitled “METHOD AND ELECTRONIC DEVICE FOR PROVIDING QUICK LAUNCH ACCESS”, the contents of which are incorporated herein by reference in their entireties.

### TECHNICAL FIELD

The present disclosure relates to the field of information processing technology, and particularly to a method and electronic device for providing a quick launch access and a storage medium.

### BACKGROUND

In prior art, providing a quick launch access for a user on a windows desktop is mainly implemented by dock software, such as objectdock, rocketdock and circledock. When a mouse moves to a set area, a software window is displayed by using a function of a hook window. In the displayed software window, the user can choose a quick launch access that is provided to launch a corresponding program.

However, when the quick launch access is provided using the dock software, an interface of the software is generally displayed in a form of a floating window. When the mouse moves to the set area, a popped-up window affects an ongoing operation by the user. For example, while the user is editing a word document, and when the mouse moves to the set area, a software window of the dock software is popped-up and this window floats over the word document being edited. If the user continues to edit the word document, a corresponding operation needed to be made on the floating software window, such as moving this floating software window away, thereby the normal operation on the word document is interrupted, which reduces the operation efficiency of the user.

### SUMMARY

According to the embodiments of the present disclosure, a method and electronic device for providing a quick launch access and a storage medium are provided to improve the operation of user efficiency.

It is provided a method implemented in an electronic device for providing a quick launch access, which includes steps of:
acquiring position information of a taskbar in an operation interface of the electronic device;
creating in the operation interface a self-defined quick launch window, and providing a quick launch access in the self-defined quick launch window;
arranging, based on the position information of the taskbar, the self-defined quick launch window adjacent to a start menu bar in the operation interface; and
in response to detecting a change of the taskbar, adjusting a position of the self-defined quick launch window based on the change of the taskbar.

It is further provided another method implemented in an electronic device for providing a quick launch access, which includes steps of:
acquiring position information of a taskbar in an operation interface of the electronic device;
creating in the operation interface a self-defined quick launch window, and providing a quick launch access in the self-defined quick launch window; and
arranging, based on the position information of the taskbar, the self-defined quick launch window adjacent to the start menu bar in the operation interface.

It is further provided an electronic device, which includes:
one or more processors;
a memory; and
one or more programs stored in the memory are executed by the one or more processors, and configured to provide a method for providing a quick launch access, where the one or more programs include:
an acquiring unit, configured to acquire position information of a taskbar in an operation interface;
a creating unit, configured to create a self-defined quick launch window, and provide a quick launch access in the self-defined quick launch window; and
a processing unit, configured to arrange the self-defined quick launch window adjacent to the Start menu bar in the operation interface based on the position information of the Taskbar.

There is further provided a storage medium storing processor-executable instructions, herein the processor provides a method for providing a quick launch access by executing the instructions, the method includes:
acquiring position information of a taskbar in an operation interface;
creating in the operation interface a self-defined quick launch window, and providing a quick launch access in the self-defined quick launch window; and
arranging, based on the position information of the taskbar, the self-defined quick launch window adjacent to the start menu bar in the operation interface.

### BRIEF DESCRIPTION OF THE DRAWINGS

In order to more clearly illustrate the technical solution in the embodiments of the present disclosure, in the following, accompanying drawings required in the description of the embodiments will be introduced simply. Obviously, the accompanying drawings in the following description are just some embodiments of the present disclosure. For those skilled in the art, other accompanying drawings can also be obtained according to these accompany drawings without any creative work.

FIG. 1 is a schematic structural diagram of an electronic device according to an embodiment of the present disclosure;

FIG. 2 is a flow block schematic diagram of a method for providing a quick launch access according to a first embodiment of the present disclosure;

FIG. 3 is a schematic structural diagram showing a position of a self-defined quick launch window according to an embodiment of the present disclosure;

FIG. 4 is a schematic structural diagram of an electronic device according to a second embodiment of the present disclosure; and

FIG. 5 is a schematic structural diagram of another electronic device according to a second embodiment of the present disclosure.

### DETAILED DESCRIPTION

In the following, the technical solution in the embodiments of the present disclosure will be described clearly and completely in conjunction with the accompanying drawings in the embodiments of the present disclosure. Obviously, the described embodiments are just a part of embodiments of the present disclosure, and are not all embodiments. All other embodiments obtained by those skilled in the art based on the embodiments of the present disclosure without any creative work will fall within the scope of protection of the present disclosure.

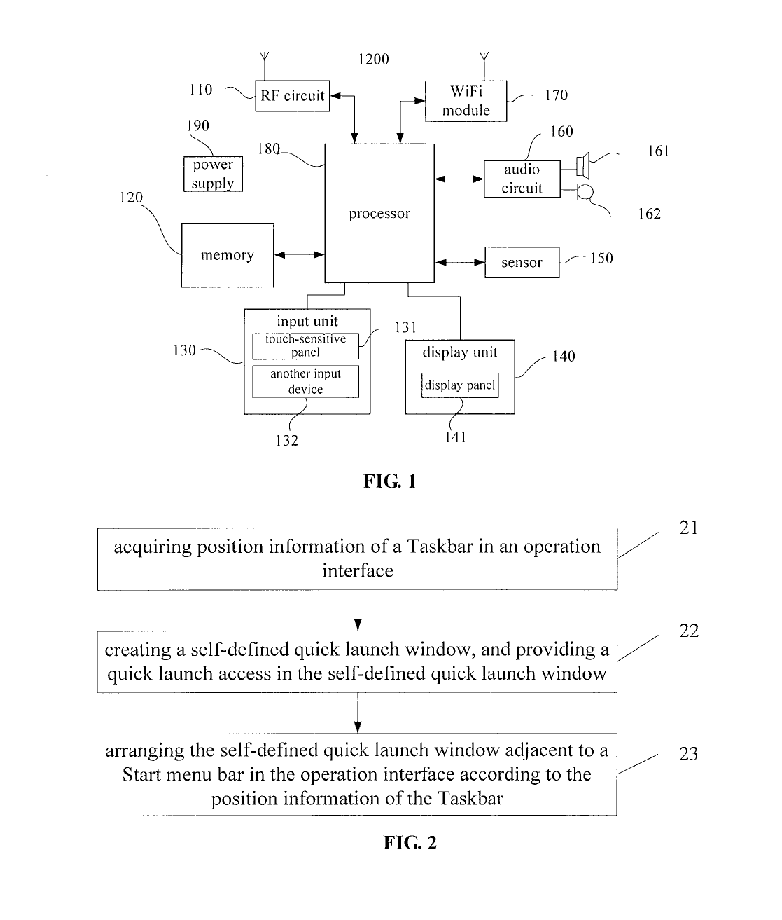

Reference is made to FIG. 1, which is a schematic structural diagram of an electronic device according to an embodiment of the present disclosure. The electronic device according to the embodiment of the present disclosure can be used to implement the method for providing a quick launch access according to the embodiments of the present disclosure.

Specifically, the electronic device 1200 may be a smart phone, a tablet PC, an e-book reader, a MP4 (Moving Picture Experts Group Audio Layer IV) player, a portable laptop computer, a desktop computer or the like. The electronic device 1200 may include a RF (Radio Frequency) circuit 110, a memory 120 including one or more computer-readable storage media, an input unit 130, a display unit 140, a sensor 150, an audio circuit 160, a processor 180 including one or more processing cores, and a power supply 190 and so on. It should be understood by those skilled in the art that the terminal is not limited to a structure of the terminal shown in FIG. 1, more or less components than shown in FIG. 5 may be included, some components may be combined, or the components may be arranged with a different approach.

The RF circuit 110 may be configured to receive and send signals during receiving or sending information or making a call, in particular, deliver downlink information of a base station to the processor 180 to process, and send uplink data to the base station. Usually, the RF circuit 110 includes an antenna, at least one of amplifier, a transceiver, a coupler, a tuner, one or more oscillators, a Subscriber Identity Module (SIM) card, a transceiver, a coupler, an LNA (Low Noise Amplifier), a duplexer etc. Furthermore, the RF circuit 110 may communicate with a network or other device via wireless communication. Any communication standard or protocol may be provided for the wireless communication, and the communication standard or protocol includes: GSM (Global System of Mobile communication), GPRS (General Packet Radio Service), CDMA (Code Division Multiple Access), WCDMA (Wideband Code Division Multiple Access), LTE (Long Term Evolution), e-mail, SMS (Short Messaging Service), etc.

The memory 120 may be configured to store an application program or module. And the processor 180 performs a method for providing a quick launch access by and data processing by running the application program or module stored in the memory 120. The memory 120 may mainly include a program memory area and a data memory area, herein, the program memory area may store an operating system, an application program required by at least one function (such as a function of playing audio, a function of playing an image), etc.; the data memory area may store data (such as audio data, a phone book, etc.) created according to the usage of the electronic device 1200, etc. Furthermore, the memory 120 may include a high speed random access memory, a nonvolatile memory such as at least one magnetic disk memory, a flash memory or other volatile solid state memory. Accordingly, the memory 120 may include a memory controller for providing access of the processor 180 and the input unit 130 to the memory 120.

The input unit 130 may be configured to receive digital information or character information input, and generate a keyboard signal input, a mouse signal input, a joystick signal input, optical or a trackball signal input related to a user setting and a function control. Specifically, the input unit 130 may include a touch-sensitive panel 131 and other input device 132. The touch-sensitive panel 131, also referred to as a touch display screen or a touch panel, can collect a touch operation (such as a operation on or near the touch-sensitive panel 131 which are performed by a user with a finger, a stylus or any suitable object or accessory, and drive corresponding connection device according to a program preset in advance. Optionally, the touch-sensitive panel 131 may include two components: a touch detection device and a touch controller. Herein, the touch detection device is configured to detect a touch location of the user, a signal caused by a touch operation, and send the signal to the touch controller; the touch controller is configured to receive touch information from the touch detection device, and convert the touch information into coordinates of a touch point, send the coordinates to the processor 180, and receive and execute a command from the processor 180 and. Furthermore, the touch-sensitive panel 131 may be implemented into many types, e.g., a resistance type, an infrared type, a Surface Acoustic Wave type, etc. Besides the touch-sensitive panel 131, the input unit 130 may also include other input device 132. Specifically, the other input device 132 may include: one or any combination of physical keyboard, function key (such as a key for controlling volume, ON/OFF key), trackball, mouse, joystick and so on.

The display unit 140 may be configured to display information input by the user, information provided to the user and various graphic user interfaces of the electronic device 1200, where these graphic user interfaces may include one or any combination of image, text, icon and video. The display unit 140 may include a display panel 141, and optionally, the display panel 141 may be configured in forms of an LCD (Liquid Crystal Display) form or an OLED (Organic Light-Emitting Diode), etc. Further, the touch-sensitive panel 131 may cover the display panel 141. And after the touch operation is detected on or near the touch-sensitive panel 131, the touch operation is sent to the processor 180 to determine the type of a touch event, and then the processor 180 provides a corresponding visual output on the display panel 141 based on the type of the touch event. Although in FIG. 1, the touch-sensitive panel 131 and the display panel 141 are implemented as two independent components to achieve input and output, the touch-sensitive panel 131 and the display panel 141 may be integrated together to achieve input and the output in some embodiments.

The electronic device 1200 may further include at least one kind of sensor 150, e.g., optical sensor, motion sensor and any other sensors. Specifically, the optical sensor may include an ambient light sensor and a proximity sensor, where the ambient light sensor may adjust the brightness of the display panel 141 based on the intensity of the ambient light, and the proximity sensor may turn off the display panel 141 and/or a backlight when the electronic device 1200 is moved near to the user's ear. As one kind of the motion sensors, a gravity acceleration sensor may detect values of accelerations on all directions (usually three0axis), and detect the value and direction of the gravity when remaining stationary, the gravity acceleration sensor may be applied in an application about mobile phone pose recognition (for example, switching between landscape and portrait, a related game, magnetometer pose calibration) and a function about vibration recognition (for example, a pedometer, knocking), etc. Other sensors, e.g., gyroscope, barometer, hygrometer, thermometer, infrared sensor, etc, which may be further provided in the electronic device 1200, are not described here in detail.

The audio circuit 160, a loudspeaker 161 and a microphone 162 may provide an audio interface between the user and the electronic device 1200. The audio circuit 160 may transmit an electric signal, converted from received audio data, to the loudspeaker 161, and a voice signal is converted from the electric signal and then output, by the loudspeaker 161; on the other hand, the microphone 162 converts a collected voice signal into an electric signal, the electric signal is received by the audio circuit 160 and converted into audio data. The audio data is output to the processor 180 to process and then sent to another terminal via the RF circuit 110; alternatively, the audio data is output to the memory 120 for further processing. The audio circuit 160 may further include a headset jack through which an external earphone and the electronic device 1200 may be connected.

The processor 180 is a control center of the electronic device 1200, and is configured to connect all components of a whole mobile phone via different interfaces and wires, and execute various functions of the electronic device 1200 and process data by running or executing the software program and/or module stored in the memory 120, and invoking the data stored in the memory 120; therefore, the whole mobile phone is monitored. Optionally, the processor 180 may include one or more processing cores; preferably, the processor 180 may be integrated with an application processor and a modem processor, where the application processor is mainly configured to process an operating system, a user interface and an application program, etc., and the modem processor is mainly configured to process wireless communication. It may be understood that the modem processor may not be integrated in the processor 180.

The electronic device 1200 may further include a power supply 190 (e.g. a battery) providing power to all the components. Preferably, the power supply may be logically connected with the processor 180 through a power supply management system in order to implement functions of charging management, discharging management, power consumption management, etc. The power supply 190 may further include elements such as one or more DC power supplies or AC power supplies, a recharging system, a power failure detection circuit, a power adapter or inverter, a power status indicator.

In addition, the electronic device 1200 may further include a communication module for establishing a communication connection between the electronic device 1200 and other device. The communication module may be a WiFi module 170 shown in FIG. 1. With the WiFi module 170, the electronic device 1200 may assist the user in sending and receiving an e-mail, browsing a webpage and accessing a stream media, etc., and a wireless broadband internet access is provided to the user. Although the WiFi module 170 is illustrated in FIG. 5, it should be understood that the WiFi module 170 is not indispensable in the electronic device 1200 and may not be provided in practice without changing the scope of essence of the present disclosure.

Although not illustrated in the drawings, the electronic device 1200 may further include a camera, a Bluetooth module, etc. In the embodiment, the display unit of the electronic device 1200 is a touch screen display. The electronic device 1200 includes a memory and one or more programs, and the one or more programs are stored in the memory and are configured to implement the method for providing a quick launch access according to the embodiments of the present disclosure in the case where executed by the one or more processors.

As shown in FIG. 2, the method for providing a quick launch access provided in the first embodiment of the present disclosure includes:

Step 21, acquiring position information of a Taskbar in an operation interface.

Here, window handles of the Taskbar and a Start button can be queried by invoking an api function provided by the operation interface (such as a windows interface), thereby the position information of the “Taskbar” is obtained. In the operation interface, the “Taskbar” may be arranged horizontally or vertically. Of course, with the development of the technology, the “Taskbar” may also be arranged in any direction in the operation interface.

Step 22, creating a self-defined quick launch window, and providing a quick launch access in the self-defined quick launch window.

Typically, the self-defined quick launch window may be created by a form of drawing the self-defined quick launch window directly. Preferably, in order to eliminate flickers which may occur in the self-defined quick launch window, in the embodiment, a Dynamic Link Library (dll) module may be injected into a system process of Explorer.exe. In the system process of Explorer.exe, a function is drawn with a hook function, and the drawing of the self-defined quick launch window is added into the drawing function, thereby the self-defined quick launch window is created.

Step 23, arranging the self-defined quick launch window adjacent to a Start menu bar in the operation interface according to the position information of the Taskbar.

For example, according to step 21, in the case where the position of the “Taskbar” is arranged horizontally in the operation interface, the self-defined quick launch window is arranged on the right of the Start menu bar (the Start menu bar here may be the “Start” menu in the Taskbar of windows) in the operation interface. In this case, for the user who has a habit of holding the mouse with the right hand, when the user moves the mouse on the icon of the self-defined quick launch window to make a click operation, moving to a lower left corner means moving to the body of the user, which can bring a more comfortable operation experience. Viewed from a visual perspective, a right first position in the Start menu easily attracts the user's attention, allowing the user to quickly find the quick launch window so as to facilitate the next click operation.

In the case where the position of the “Taskbar” is arranged vertically in the operation interface, the self-defined quick launch window is arranged on the under-side of the “Start” menu in the operation interface.

In the existing operation interface, the self-defined quick launch window may be arranged between the “Start” menu and the “quick launch bar” of the operation interface. In that case, a window in the “Taskbar” which is currently located between the “Start” menu and “quick launch bar” of the operation interface may be moved away from the “Start” menu through the api of the operation interface, so that a space for arranging the self-defined window (access) is left. For example, in the case where the “Taskbar” is arranged horizontally in the operation interface, a window in the “Taskbar” which is currently located at this position is moved to the right; in the case where the “Taskbar” is arranged vertically in the operation interface, a window in the “Taskbar” which is currently located at this position is moved down. Alternatively, the self-defined quick launch window may be directly arranged at a position of a window in the “Taskbar” which is currently adjacent to the “Start” menu. Thus, the position of the self-defined quick launch window is overlapped with the position of the window in the “Taskbar” which is currently adjacent to the “Start” menu, or the position of the self-defined quick launch window covers the position of the window in the “Taskbar” which is currently adjacent to the “Start” menu. Thereby the space in the “Taskbar” can be saved more effectively.

In this case, since the self-defined quick launch window is located at the position adjacent to the “Start” menu, for the user who is accustomed to Windows operation, the position of the self-defined quick launch window is located at the first place of the quick launch bar and closer to the Start menu which is clicked often, which conforms with the user's habits in operation, and to facilitate the click operation of the user.

The self-defined quick launch window can respond to a keyboard and a mouse through a message mechanism of Windows, various events such as global keyboard shortcuts, a left mouse button, a right mouse button and a mousehover can be triggered in variety of situations, and a response can be made according to the corresponding event.

As described above, since the self-defined quick launch window is located at a position adjacent to the “Start” menu, in the case where there is an opened window or a running program, the opened self-defined quick launch window does not block main contents of the opened program or document, and does not affect the operations of the user on other programs or documents. Therefore, the user experience is improved with the solution according to the first embodiment of the present disclosure.

Further, based on the first embodiment, the change of the “Taskbar” such as the movement of the position of the “Taskbar”, the height change of the “Taskbar”, the window hierarchy change of the “Taskbar” and the occurrence of abnormality can also be detected periodically. For example, a timer can be set, and the change of the “Taskbar” can be detected within set time of the timer. For example, the change of the “Taskbar” can also be detected through a forward method performed by a hook mechanism. Through detecting the change of the “Taskbar”, the position of the self-defined quick launch window can be better adjusted according to the position of the “Taskbar”. Further, through the hook mechanism, the efficiency can be improved and the flicker produced in refreshing can be solved well.

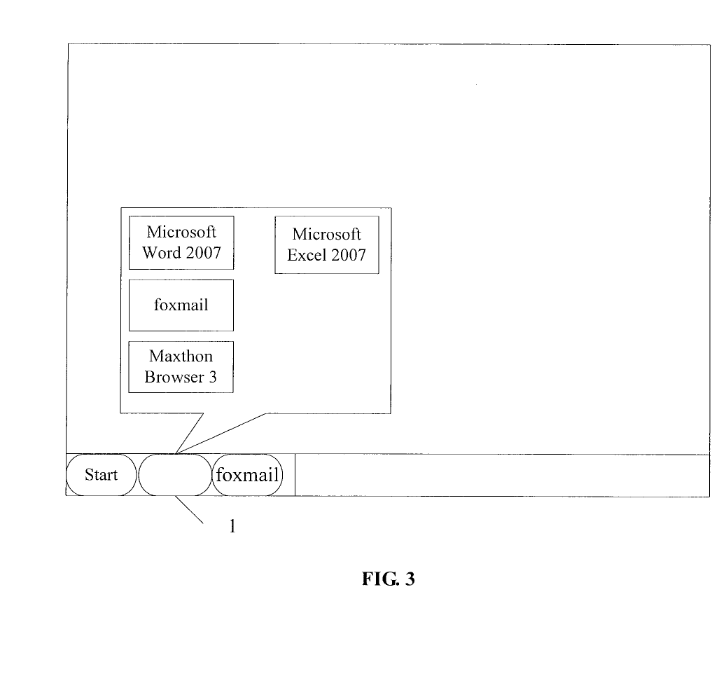

FIG. 3 is a schematic structural diagram showing a position of a self-defined quick launch window according to an embodiment of the present disclosure. As shown in FIG. 3, it is a schematic diagram showing a position of a self-defined quick launch window 1 in the case where a “Taskbar” is arranged horizontally.

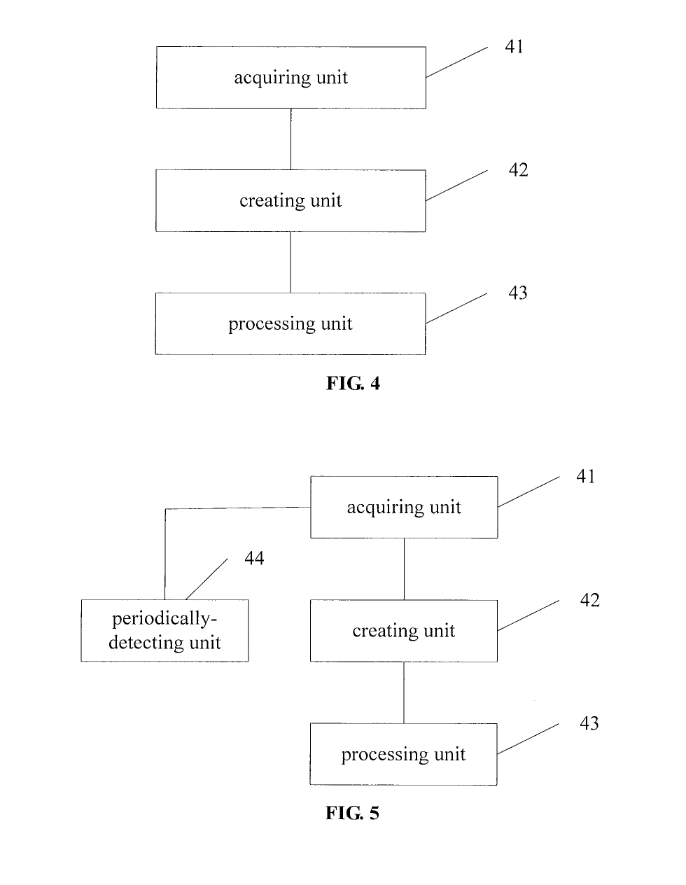

FIG. 4 is a schematic structural diagram of an electronic device according to a second embodiment of the present disclosure, as shown in FIG. 4, the electronic device according to the second embodiment of the present disclosure includes:
an acquiring unit 41, configured to acquire position information of a “Taskbar” in an operation interface; a creating unit 42, configured to create a self-defined quick launch window, and provide a quick launch access in the self-defined quick launch window; and a processing unit 43, configured to arrange the self-defined quick launch window at a position adjacent to the “Start” menu bar in the operation interface according to the position information of the “Taskbar”.

Where, the creating unit 42 includes: an injecting module, configured to inject a Dynamic Link Library module into a system process; and a drawing module, configured to create, in the system process, the self-defined quick launch window using a drawing function of a hook function, and a quick launch access is in the self-defined quick launch window. The case that flickers occur in the self-defined quick launch window can be eliminated. Alternatively, the creating unit 42 may be specifically configured to create the self-defined quick launch window using a drawing function.

The “Taskbar” may be arranged horizontally or vertically in the operation interface according to detection of the acquiring unit 41. Therefore, the processing unit may be specifically configured to: arrange the self-defined quick launch window on the right of the “Start” menu in the operation interface in the case where the “Taskbar” is arranged horizontally in the operation interface; or arrange the self-defined quick launch window on the under-side of the “Start” menu in the operation interface in the case where the “Taskbar” is arranged vertically in the operation interface.

As described above, in order to conform to the user's click habits, and to further improve the user experience, the processing unit may arrange the self-defined quick launch window between the “Start” menu and the “quick launch bar” in the operation interface. In addition, the processing unit is further configured to move a window in the “Taskbar”, which is between the “quick launch bar” and the “Start” menu in the operation interface, away from the “Start” menu so as to reserve space to arrange the “quick launch bar”.

Alternatively, in order to conform to the user's click habits, and to further improve the user experience, the processing unit may also arrange the self-defined quick launch window at a position of the window in the “Taskbar” which is currently adjacent to the “Start” menu. In that case, the space in the “Taskbar” can be saved more effectively.

FIG. 5 is a schematic structural diagram of another electronic device according to the second embodiment of the present disclosure. As shown in FIG. 5, in order to change the position of the self-defined quick launch window better according to the position of the “Taskbar”, the electronic device further includes: a periodically-detecting unit 44, configured to detect the change of the “Taskbar” periodically, such as the movement of the position of the “Taskbar”, the height change of the “Taskbar”, the window level change of the “Taskbar”, the occurrence of abnormalities.

For a working principle of the electronic device, one can refer to the description of the foregoing method embodiments.

As described above, since the self-defined quick launch window is located at the position adjacent to the “Start” menu, when there is an opened window or a running program, the opened self-defined quick launch window does not block main contents of the opened program or document. Therefore, operations of a user on other programs or documents can not be affected, the user experience is improved with the solution according to the second embodiment of the present disclosure.

Those skilled in the art can be understood that all or part of the process in the methods of the above embodiments can be completed through a computer program instructing a relevant hardware, the program can be stored in a computer readable storage medium, and when this program is executed, the process of the embodiments of the methods described above can be implemented. Wherein the storage medium may be a magnetic disk, an optical disk, a Read-Only Memory (ROM), or a Random Access Memory (RAM), etc.

The described above are only embodiments of the present disclosure, and are not intended to limit the scope of the present disclosure, any equivalent structure or equivalent process transformation made to the contents of the specification and the drawings of the present disclosure, or any direct or indirect application of the contents of the specification and the drawings of the present disclosure to other related technology fields, are also included in the scope of protection of the present disclosure.

1. A method implemented in an electronic device for providing a quick launch access, comprising:
acquiring position information of a taskbar in an operation interface of the electronic device;
creating in the operation interface a self-defined quick launch window, and providing a quick launch access in the self-defined quick launch window;
arranging, based on the position information of the taskbar, the self-defined quick launch window adjacent to a start menu bar in the operation interface; and
in response to detecting a change of the taskbar, adjusting a position of the self-defined quick launch window based on the change of the taskbar.

2. The method according to claim 1, wherein the creating in the operation interface a self-defined quick launch window and providing a quick launch access in the self-defined quick launch window comprises:
creating in the operation interface the self-defined quick launch window by using a drawing function.

3. The method according to claim 1, wherein the creating in the operation interface a self-defined quick launch window and providing a quick launch access in the self-defined quick launch window comprises:
injecting a dynamic link library (DLL) module into a system process; creating, in the system process, the self-defined quick launch window using a drawing function of a hook function, and providing the quick launch access in the self-defined quick launch window.

4. The method according to claim 1, wherein the arranging, based on the position information of the taskbar, the self-defined quick launch window adjacent to a start menu bar in the operation interface, comprises:
arranging the self-defined quick launch window on the right of the start menu bar in the operation interface in the case where the taskbar is arranged horizontally in the operation interface.

5. The method according to claim 1, wherein the arranging, based on the position information of the taskbar, the self-defined quick launch window adjacent to a start menu bar in the operation interface, comprises:
arranging the self-defined quick launch window on the under-side of the start menu in the operation interface in the case where the taskbar is arranged verticality in the operation interface.

6. The method according to claim 4, wherein the self-defined quick launch window is arranged between the start menu bar and a quick launch bar in the operation interface, or in the taskbar and adjacent to the start menu bar.

7. The method according to claim 6, wherein in the case where the self-defined quick launch window is arranged between the start menu bar and the quick launch bar in the operation interface, after the acquiring position information of the taskbar in the operation interface, the method further comprises:
moving, a window in the taskbar and between the quick launch bar and the start menu bar of the operation interface, away from the start menu bar.

8. A method implemented in an electronic device for providing a quick launch access, comprising:
acquiring position information of a taskbar in an operation interface of the electronic device;
creating in the operation interface a self-defined quick launch window, and providing a quick launch access in the self-defined quick launch window; and
arranging, based on the position information of the taskbar, the self-defined quick launch window adjacent to a start menu bar in the operation interface.

9. The method according to claim 8, wherein the creating in the operation interface a self-defined quick launch window and providing a quick launch access in the self-defined quick launch window comprises:
creating in the operation interface the self-defined quick launch window by using a drawing function.

10. The method according to claim 8, wherein the creating a self-defined quick launch window and providing a quick launch access in the self-defined quick launch window comprises:
injecting a dynamic link library (DDL) module into a system process; creating, in the system process, the self-defined quick launch window using a drawing function of a hook function, and providing the quick launch access in the self-defined quick launch window.

11. The method according to claim 8, wherein the arranging, based on the position information of the taskbar, the self-defined quick launch window adjacent to a start menu bar of the operation interface, comprises:
arranging the self-defined quick launch window on the right of the start menu bar in the operation interface in the case where the taskbar is arranged horizontally in the operation interface.

12. The method according to claim 8, wherein the arranging, based on the position information of the taskbar, the self-defined quick launch window adjacent to a start menu bar in the operation interface, comprises:
arranging the self-defined quick launch window on the under-side of the start menu in the operation interface in the case where the taskbar is arranged verticality in the operation interface.

13. The method according to claim 11, wherein the self-defined quick launch window is arranged between the start menu bar and a quick launch bar of the operation interface, or in the taskbar and adjacent to the start menu bar.

14. The method according to claim 13, wherein in the case where the self-defined quick launch window is arranged between the start menu bar and the quick launch bar in the operation interface, after the acquiring position information of the taskbar in the operation interface, the method further comprises a step of:
moving, a window in the taskbar and between the quick launch bar and the start menu bar of the operation interface, away from the start menu bar.

15. The method according to claim 8, wherein after the arranging the self-defined quick launch window adjacent to a start menu bar in the operation interface according to the position information of the taskbar, the method further comprises:
detecting a change of the taskbar periodically.

16. An electronic device, comprising:
a processor;
a memory; and
a program stored in the memory is executed by the processor, and configured to implement a method for providing a quick launch access, wherein
the program comprises:
an acquiring unit, configured to acquire position information of a taskbar in an operation interface;
a creating unit, configured to create a self-defined quick launch window, and provide a quick launch access in the self-defined quick launch window; and
a processing unit, configured to arrange the self-defined quick launch window adjacent to a Start menu bar in the operation interface based the position information of the Taskbar.

17. The electronic device according to claim 16, wherein the processing unit is configured to:
arrange the self-defined quick launch window on the right of the start menu in the operation interface, in the case where the taskbar is arranged horizontally in the operation interface;
arrange the self-defined quick launch window on the under-side of the start menu in the operation interface, in the case where the taskbar is arranged vertically in the operation interface.

18. The electronic device according to claim 17, wherein the processing unit is configured to arrange the self-defined quick launch window between the start menu bar and a quick launch bar of the operation interface, or arrange the self-defined quick launch window in the taskbar and adjacent to the start menu bar.

19. The electronic device according to claim 16, further comprising:
a periodically-detecting detecting unit, configured to detect a change of the taskbar periodically.

20. A non-transitory storage medium in which processor-executable instructions are stored, wherein a processor provides a method for providing a quick launch access by executing the instructions, the method comprises:
acquiring position information of a taskbar in an operation interface;
creating in the operation interface a self-defined quick launch window, and providing a quick launch access in the self-defined quick launch window; and
arranging, based on the position information of the taskbar, the self-defined quick launch window adjacent to a start menu bar in the operation interface.
